(19) United States
(12) Patent Application Publication
(10) Pub. No.: US 2014/0032420 A1
(43) Pub. Date: Jan. 30, 2014

(54) METHOD FOR PROVIDING SOLUTION OF PERIPHERAL TECHNIQUE

(71) Applicant: GUDENG PRESCISION INDUSTRIAL CO., LTD., New Taipei City (TW)

(72) Inventors: MING-CHIEN CHIU, NEW TAIPEI CITY (TW); CHIEN-LUNG HSU, NEW TAIPEI CITY (TW)

(73) Assignee: GUDENG PRECISION INDUSTRIAL CO., LTD., NEW TAIPEI CITY (TW)

(21) Appl. No.: 13/706,508

(22) Filed: Dec. 6, 2012

(30) Foreign Application Priority Data
Jul. 30, 2012 (TW) 101127533

(51) Int. Cl. G06Q 30/00

(52) U.S. Cl. CPC G06Q 30/016
USPC 705/304

(57) ABSTRACT

A method for providing peripheral technical support is revealed. A search of a peripheral technical problem is performed by a first server or a second server so that a peripheral supplier provides a firm a peripheral technology solution the firm required. Moreover, an external technology solution obtained by the second server is stored in the first server so as to expand the first server. While providing the solution for the problem of the external technique, the peripheral supplier also provides the firm a peripheral technical report or a peripheral technical model. Thus a better technical support is offered, allowing the firm to solve the peripheral technical problem the firm encountered.

### BACKGROUND OF THE INVENTION

1. Fields of the invention

The present invention relates to a method for providing technical support, especially to a method for providing a solution of a peripheral technique in which a peripheral supplier transmits the solution of the peripheral technique in response to a problem of the peripheral technique a firm encountered while using the peripheral technique so as to help the firm to solve the problem of the peripheral technique.

2. Descriptions of Related Art

There are two types of techniques a firm should have. The first type techniques are onsite techniques of the firm while the other type techniques are peripheral techniques the firm acquired from peripheral suppliers or suppliers (resources). Take a silicon wafer plant as an example, the first type techniques related to silicon wafer manufacturing processes, such as disposition, etching etc., are performed in the plant. The second type techniques are associated with designing and manufacturing of reticle packages used to retain reticles. The reticle is used during the etching process. The silicon wafer plant doesn't produce the reticle packages so that the reticle packages are acquired from external suppliers.

While acquiring the second-type techniques related to materials or machines from the peripheral suppliers or the external suppliers, the materials or machines may have poor quality, damages or other problem. Thus the firm needs supports of the second-type techniques from the peripheral suppliers or the external suppliers to solve the problems of the second-type techniques. Thus the present invention provides a method for providing a solution of the peripheral technique. The techniques corresponding to different sources (firms) are categorized into core techniques and peripheral techniques. The core techniques represent onsite techniques of the firm while the peripheral techniques mean offsite techniques the firm acquired from peripheral suppliers or external suppliers. The problems of the peripheral technique the firm met in use are transmitted to peripheral suppliers. Then the peripheral suppliers perform a search by a first server or a second server to get solutions corresponding to the problems of the peripheral techniques. The peripheral techniques are further divided into internal techniques and external techniques. The internal techniques represent techniques developed in the peripheral supplier. The external techniques mean techniques the peripheral supplier acquired from other suppliers. The first server is provided by the peripheral supplier and is used to save the internal techniques and search solutions for problems of internal technique. The second server is provided by an external supplier and is used to save the external techniques and search solutions for problems of external technique. Moreover, the solutions for external techniques obtained by searching of the second server can be stored in the first server.

Accordingly, the method of the present invention not only allows peripheral suppliers to provide the firms solutions of peripheral technique, it also digitizes peripheral techniques in a database and provides a problem-oriented expansion of the database of the peripheral techniques. Besides solutions of peripheral technique, peripheral suppliers also provide firms other technique supports including peripheral technique reports or peripheral technique models. According to requirements of core firms, customized adjustment comments of peripheral techniques or models/samples for customizing and adjusting peripheral techniques are provided to allow the core firms testing the peripheral techniques and confirming efficiencies of the customized adjustment of peripheral techniques.

### SUMMARY OF THE INVENTION

Therefore it is a primary object of the present invention to provide a method for providing a solution of peripheral technique in which the solution of peripheral technique is obtained through a database provided by a peripheral supplier. Thus a problem of the peripheral technique a core firm encountered can be solved.

It is another object of the present invention to provide a method for providing a solution of peripheral technique that digitizes and saves solutions related to peripheral techniques in a database so as to search and get a corresponding solution for problem of peripheral technique.

It is a further object of the present invention to provide a method for providing a solution of peripheral technique in which a database of a peripheral supplier is introduced to save a solution obtained from a database of an external supplier for problem-oriented expansion of the database of the peripheral supplier.

It is a further object of the present invention to provide a method for providing a solution of peripheral technique in which a peripheral supplier provides a peripheral technique report or a peripheral technique model related to a peripheral technique problem for satisfying requirements of a core firm and solving the peripheral technique problem.

In order to achieve the above objects, a method for providing a solution of peripheral technique of the present invention includes following steps. In the beginning, define at least one core technique and at least one peripheral technique of a firm. Use a first terminal of the firm to connect with a first server provided by a peripheral supplier. Then transmit a problem of the peripheral technique the firm encountered while using the peripheral technique to the first server, and search and get a solution for problem of the peripheral technique by the first server for retrieval of a solution of the peripheral technique corresponding to the problem of the peripheral technique.

The core technique is an onsite technique of the firm while the peripheral technique is an offsite technique the firm acquired from the peripheral supplier. The first server includes at least one peripheral technique library (database) that is set up by the peripheral supplier and is stored in a first storage device at a proximal end of the first server or a first cloud device at a rear end of the first server. While the peripheral technique solution is transmitted to the first terminal by the first server, the peripheral supplier also transmits a peripheral technique report or a peripheral technique model to the firm for helping the firm to solve the peripheral technique problem.

Moreover, the peripheral technique further includes at least one internal technique or at least at least one external technique. The internal technique means that the technique is developed inside the peripheral supplier while the external technique is the technique the peripheral supplier acquired from external supplier. After the firm transmitting a problem of external technique to the first server by the first terminal, the peripheral supplier transmits the problem of the external technical to a second server by a second terminal. The second server is provided by the external supplier. Then search and obtain a solution of external technique by the second server in response to the problem of the external technique. By the first server, the peripheral supplier transmits the solution of the external technique to the first terminal and saves the solution of the external technique in the first server. The external supplier can transmit an external technique report or an external technique model to the peripheral supplier when the solution of the external technique is transmitted to the second terminal by the second server. The peripheral supplier can also transmit the external technique report or the external technique model to the firm while the first server transmits the solution of the external technique to the first terminal so as to assist the firm to solve the problem of the external technique.

According to the method for providing a solution of the peripheral technique of the present invention, a peripheral supplier provides a peripheral technique support containing a solution of the peripheral technique for assisting the firm to solve a problem of the peripheral technique. Moreover, the problems of the peripheral technique already known and the corresponding solutions of the peripheral technique are digitized in a database and are stored in a first server having at least one peripheral technique library. An external technique solution obtained from a second server provided by an external supplier with an external technique is also stored in the first server. Thus the first server is expanded according to the problems occurred. Furthermore, the peripheral supplier can also provide a peripheral technique report or a peripheral technique model while providing the peripheral technique solution. Thus customized adjustment of the peripheral technique or models/samples produced by the customized and adjusted peripheral technique can be provided by the peripheral supplier according to requirements of the firm. Therefore the firm can test the peripheral technique and confirm effects of the customized adjustment of peripheral technique.

The present invention not only enables a peripheral supplier to provide a solution by the first server in response to a peripheral technique problem submitted by a firm, but also obtains a solution by a second server provided by an external supplier and saves the solution in the first server. Thus the first server is expanded according to the external technique problems occurred. Moreover, the peripheral supplier provides the core firm various support including technique solutions, reports and models/samples the firm needed. The peripheral techniques are digitized in a database and problem-oriented expansion of the database is achieved.

### BRIEF DESCRIPTION OF THE DRAWINGS

The structure and the technique means adopted by the present invention to achieve the above and other objects can be best understood by referring to the following detailed description of the preferred embodiments and the accompanying drawings, wherein

FIG. 1 is a flow chart showing steps of an embodiment according to the present invention;

FIG. 2 is a schematic drawing showing component relationships of an embodiment according to the present invention;

FIG. 3 is a flow chart showing steps of another embodiment according to the present invention;

FIG. 4 is a schematic drawing showing component relationships of another embodiment according to the present invention.

### DETAILED DESCRIPTION OF THE PREFERRED EMBODIMENT

A method for providing a solution of the peripheral technique of the present invention features on that a search is performed by a first server or a second server so that a peripheral supplier can provide a firm a peripheral technique solution and a related peripheral technique report or a peripheral technique model in response to a peripheral technique problem submitted by the firm. The second server is provided by an external supplier and the peripheral technique solution obtained by the second server is stored in the first server so as to expand the first server. Thus the problems and corresponding solutions associated with the peripheral techniques are digitized in a database, the database is expanded based on the problems occurred and the peripheral technique problems the core firm encountered are solved.

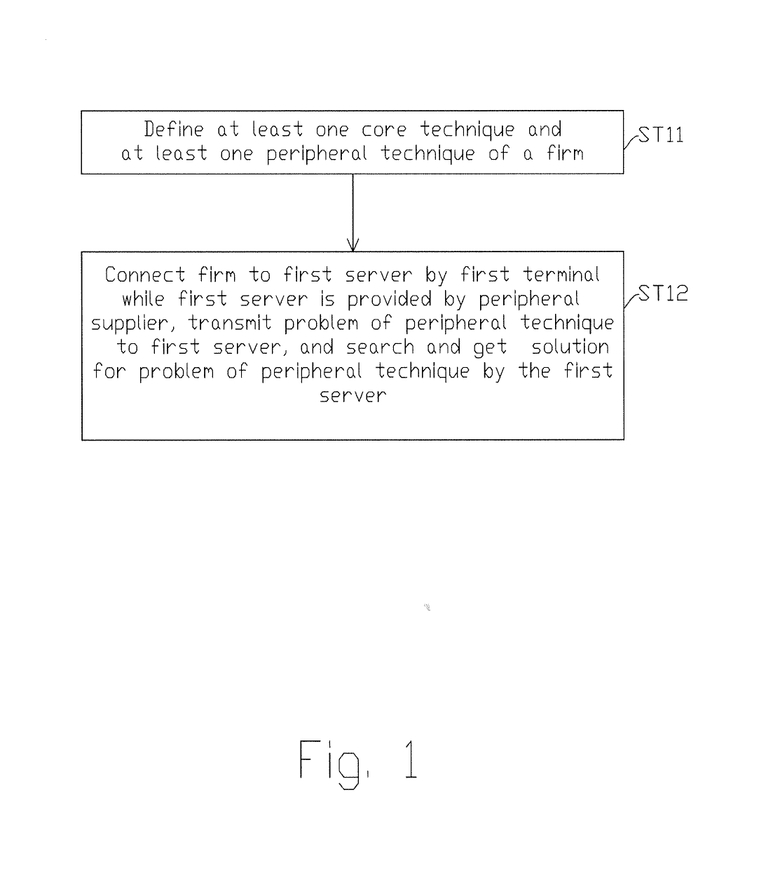

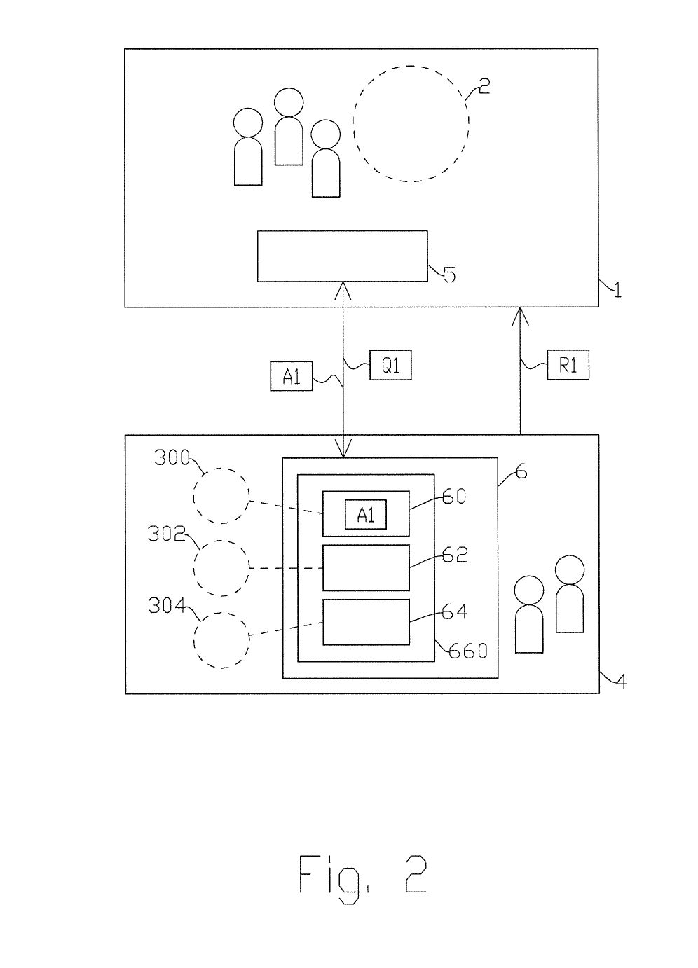

Refer to FIG. 1 and FIG. 2, a method for providing a solution of the peripheral technique includes following steps:
ST11: Define at least one core technique and at least one peripheral technique of a firm;
ST12: Connect the firm to a first server by a first terminal while the first server is provided by a peripheral supplier, transmit a problem of the peripheral technique to the first server, and search and get a solution of the peripheral technique by the first server in response to the problem of the peripheral technique.

Refer to FIG. 2 first define a core technique 2 and three peripheral techniques 300, 302, 304 of a firm 1. The peripheral techniques 300, 302, 304 are respectively a first peripheral technique 300, a second peripheral technique 302, and a third peripheral technique 304. The core technique 2 is an onsite techniques of the firm 1 while the peripheral techniques 300, 302, 304 are offsite techniques of the firm 1 and are provided by a peripheral supplier 4. The peripheral supplier 4 has a first server 6 including three peripheral technique libraries 60, 62, 64, respectively a first peripheral technique library 60, a second peripheral technique library 62, and a third peripheral technique library 64. The first peripheral technique library 60 includes content of the first peripheral technique 300. The second peripheral technique library includes content related to the second peripheral technique 302. The third peripheral technique library 64 includes content of the third peripheral technique 304. The peripheral technique libraries 60, 62, 64 are set up by the peripheral supplier 4 and stored in a first storage device 660 at a proximal end of the first server 6. The firm 1 has a first terminal 5 used to connect to the first server 6 for transmitting a peripheral technique problem Q1 to get a peripheral technique solution A1. The peripheral supplier 4 provides the firm 1 a peripheral technique report R1.

When the firm 1 encounters the peripheral technique problem Q1 while using the peripheral techniques 300, 302, and 304, the firm 1 is connected to the first server 6 by the first terminal 5 and then the peripheral technique problem Q1 is transmitted to the first server 6. Search the peripheral technique libraries 60, 62, 64 of the first server 6 for retrieval of the peripheral technique solution A1 from the peripheral technique library 60. While the peripheral technique solution A1 is delivered from the first server 6 to the first terminal 5, the peripheral supplier 4 also sends the peripheral technique report R1 to the firm 1. The peripheral technique report R1 is made by the peripheral supplier 4 in response to a partial adjustment of the first peripheral technique 300 made by the firm 1 so as to allow the firm 1 to evaluate effects of customized adjustment on the first peripheral technique 300.

Thus a peripheral supplier saves peripheral techniques already-known in the first server so that a firm can perform a search by the first server in order to get a solution of peripheral technique and solve a problem of the peripheral technique the firm encountered. Moreover, a peripheral technique report or a peripheral technique model is also provided so as to digitize peripheral techniques in a database for various applications.

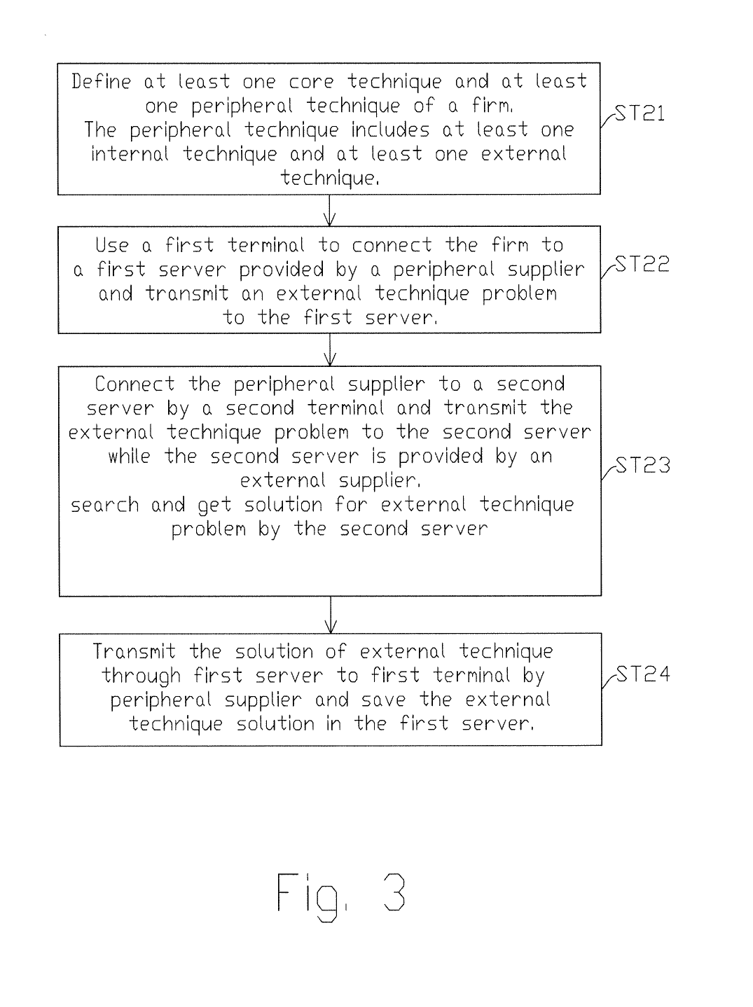

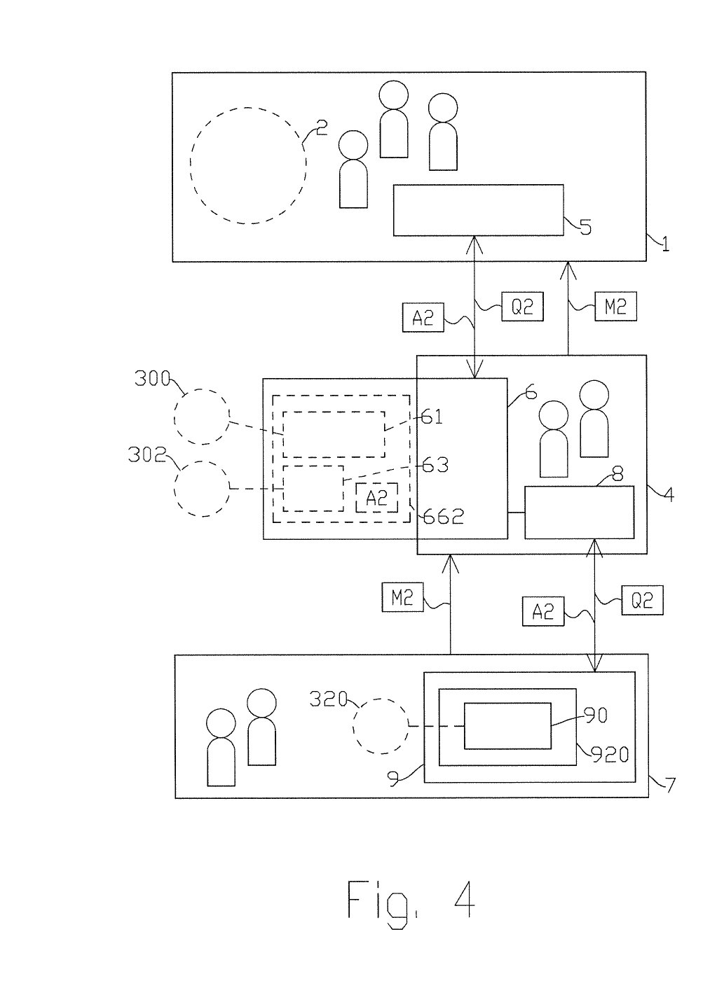

Refer to FIG. 3 and FIG. 4, steps and component relationship of another embodiment according to the present invention are revealed. As shown in FIG. 3, a method for providing solution of peripheral technique includes following steps:
ST21: Define at least one core technique and at least one peripheral technique of a firm. The peripheral technique includes at least one internal technique and at least one external technique.
ST22: Use a first terminal to connect the firm to a first server provided by a peripheral supplier and transmit an external technique problem to the first server.
ST23: Connect the peripheral supplier to a second server by a second terminal and transmit the external technique problem to the second server while the second server is provided by an external supplier. Perform a search of the external technique problem by the second server to get an external technique solution for the external technique problem.
ST24: Transmit the external technique solution through the first server to the first terminal by the peripheral supplier and save the external technique solution in the first server.

As shown in FIG. 4, a core technique 2 and three peripheral techniques 300, 302, 320 of a firm 1 are defined. The peripheral techniques 300, 302, 320 are respectively a first peripheral technique 300, a second peripheral technique 302, and a third peripheral technique 320. These peripheral techniques 300, 302, 320 are further divided into two internal techniques 300, 302 and one external technique 320. The core technique 2 is an onsite technique of the firm 1 while the peripheral techniques 300, 302, 320 are offsite techniques the firm 1 acquired from other suppliers. The two peripheral techniques 300, 302 are techniques developed in a peripheral supplier 4 while the external technique 320 is the technique the peripheral supplier 4 acquired offsite. An external supplier 7 provides the peripheral supplier 4 the external technique 320 and the peripheral supplier 4 provides the firm 1 the peripheral techniques 300, 302, 320. The external supplier 7 has a second server 9 that includes an external technique library 90 in which the external technique 320 is stored. The external technique library 90 is set up by the external supplier 7 and is stored in a second storage device 920 at a proximal end.

The peripheral supplier 4 has a second terminal 8 and a first server 6. There are two peripheral technique libraries-a first peripheral technique library 60 and a second peripheral technique library of the first server 6. The first peripheral technique library 60 contains the first peripheral technique 300 and the second peripheral technique library 62 contains the second peripheral technique 302. The peripheral technique libraries 60, 62 are set up by the peripheral supplier 4 and are stored in a first cloud device 662 at a rear end. The second terminal 8 is connected to the second server 9 and is transmitted an external technique problem Q2 to get an external technique solution A2. Moreover, the external supplier 7 provides the peripheral supplier 4 an external technique model M2. A first terminal 5 of the firm 1 is connected to the first server 6 for transmitting the external technique problem Q2 in order to get the external technique solution A2. The peripheral supplier 4 provides the firm 1 the external technique model M2. The second storage device 920 can be replaced by a second cloud device (not shown in figure).

In this embodiment, once the firm 1 encounters the external technique problem Q2 while using the peripheral techniques 300, 302, and 320, the firm 1 is connected to the first server 6 by the first terminal 5 for transmitting the external technique problem Q2 to the first server 6. The peripheral supplier 4 connects to the second server 9 by the second terminal 8 and transmits the external technique problem Q2 to the second server 9. Search the external technique library 90 contained in the second server 9 to obtain the external technique solution A2. While the external technique solution A2 is transmitted to the second terminal 8 by the second server 9, the external supplier 7 also sends the external technique model M2 to the peripheral supplier 4. Then the peripheral supplier 4 transmits the external technique solution A2 to the first terminal 5 by the first server 6 and provides the external technique model M2 to the firm 1. The peripheral supplier 4 stores the external technique solution A2 in the first server 6. The external technique model M2 is made by the external supplier 7 according to the firm's requirements for adjusting the external technique 320 so as to enable the firm 1 to evaluate effects of customized adjustment on the external technique 320.

Thus by introduction of an external supplier, an external technique solution is searched and obtained by a second server of the external supplier. Thus external techniques not contained in the first server of the peripheral supplier are obtained. The external technique solution is stored in the first server for problem-oriented expansion of the first server.

In summary, a method for providing a solution of the peripheral technique of the present invention includes a plurality of steps. First define at least one core technique and at least one peripheral technique of a firm. Use a first terminal to connect the firm to a first server provided by a peripheral supplier. Then transmit a problem of the peripheral technique to the first server, and search and get a solution for the problem of the peripheral technique by the first server for retrieval of a peripheral technique solution corresponding to the problem of the peripheral technique. The peripheral technique further includes at least one internal technique or at least one external technique. By a second terminal being connected to a second server provided by an external supplier, an external technique problem is transmitted to the second server. Perform a search of the external technique problem so as to get a corresponding external technique solution and save the external technique solution in the first server. According to these steps, the method for providing a solution of the peripheral technique of the present invention digitizes the peripheral technique in a database, provides a problem-oriented expansion of the database and offers a firm peripheral technique support.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A method for providing a solution of a peripheral technique comprising the steps of:
defining at least one core technique and at least one peripheral technique of a firm, wherein the core technique is an onsite research technique of the firm while the peripheral technique is an offsite research technique of a peripheral supplier; and
connecting to a first server by a first terminal of the firm while the first server is provided by the peripheral supplier;
transmitting a problem of the peripheral technique to the first server; and
searching and getting a solution for the problem from the first server to the first terminal.

2. The method as claimed in claim 1, wherein the first server includes at least one peripheral technique library while the peripheral technique library is set up by the peripheral supplier and is stored in a first storage device at a proximal end of the first server or a first cloud device at a rear end of the first server.

3. The method as claimed in claim 1, wherein the peripheral supplier transmits a peripheral technique report or a peripheral technique model to the first terminal of the firm while the first server transmits the solution for the problem to the first terminal.

4. The method as claimed in claim 1, wherein the peripheral technique includes at least one internal technique or at least one external technique; the internal technique is a technique developed inside the peripheral supplier while the external technique is a technique the peripheral supplier acquired from an external supplier.

5. The method as claimed in claim 4, wherein the peripheral supplier is connected to a second server of the external supplier by a second terminal after the firm transmits a problem of the external technique to the first server so as to transmit the problem of the external technique to the second server, search and capture a solution for the problem of the external technique for transmitting to the first server, and transmit the solution for the problem of the external technique to the first terminal by the first server.

6. The method as claimed in claim 5, wherein when the solution for the problem of the external technique is transmitted to the first terminal by the first server, the solution for the problem of the external technique is also stored in the first server.

7. The method as claimed in claim 5, wherein the first server includes at least one peripheral technique library that is set up by the peripheral supplier and is stored in a first storage device at a proximal end or a first cloud device at a rear end.

8. The method as claimed in claim 5, wherein the second server includes at least one external technique library that is set up by the external supplier and is stored in a second storage device at a proximal end of the second server or a second cloud device at a rear end of the second server.

9. The method as claimed in claim 5, wherein the external supplier also transmits an external technique report or an external technique model to the peripheral supplier while the solution for the problem of the external technique is transmitted to the second terminal by the second server.

10. The method as claimed in claim 9, wherein the peripheral supplier also transmits an external technique report or an external technique model to the firm while the first server transmits the solution for the problem of the external technique to the first terminal.
